(19) United States
(12) Patent Application Publication
(10) Pub. No.: US 2013/0132361 A1
(43) Pub. Date: May 23, 2013

(54) INPUT METHOD FOR QUERYING BY USING A REGION FORMED BY AN ENCLOSED TRACK AND SYSTEM USING THE SAME

(71) Applicants: Liang-Pu CHEN, New Taipei City (TW); Ping-Che Yang, Kaohsiung City (TW); Tsun Ku, Taipei City (TW); Wen-Tai Hsieh, Taipei City (TW)

(72) Inventors: Liang-Pu CHEN, New Taipei City (TW); Ping-Che Yang, Kaohsiung City (TW); Tsun Ku, Taipei City (TW); Wen-Tai Hsieh, Taipei City (TW)

(21) Appl. No.: 13/545,612

(22) Filed: Jul. 10, 2012

(30) Foreign Application Priority Data
Nov. 22, 2011 (TW) 100142757

(51) Int. Cl. G06F 17/30

(52) U.S. Cl. 707/706; 707/E17.108

(57) ABSTRACT

An input method and a system for querying by using at least one region formed by at least one enclosed track are provided. The method mainly includes: forming at least one region on digital type information; storing at least one of text information and image information in the track into a registering memory; generating at least one of text-based information retrieval and image-based information retrieval according to the at least one of the text information and the image information; and finally, transmitting the at least one of the text-based information retrieval and the image-based information retrieval to at least one search engine for querying.

### CROSS-REFERENCE TO RELATED APPLICATION

This application claims the benefit of Taiwan Patent Application No. 100142757, filed on Nov. 22, 2011, which is hereby incorporated by reference for all purposes as if fully set forth herein.

### BACKGROUND OF THE INVENTION

1. Field of Invention

The present invention relates to an input method, system and device for querying by using at least one region formed by at least one enclosed track, and more particularly to an input method, system and device for querying by drawing an enclosed track on the text and/or image to be queried.

2. Related Art

In recent years, with increasing convenience of electronic devices (for example, a computer and a portable device), these devices have become daily necessities for the people. In addition, due to the popularity of network, applications related to electronic devices used in the network have gradually received much attention.

For example, a network service provider may provide a search engine for users to query by inputting key words, and perform associated network query according to the key words. Generally speaking, in spite of the specific kind of query, the query must be performed by inputting texts or pictures through the electronic device to connect a corresponding search engine by accessing a network address. And then, the user needs to manually input key words to the search engine for querying information.

The current query methods applied to the electronic device are generally classified into the following three methods:

1. The text or the picture is used as the query key words/pattern for the search engine to search.

2. Optical lens units are used as an input device.

3. A touch panel is used as an input device, in which the information can be inputted by touching the touch panel.

However, the above query methods all have inconvenience, and the prior art has the following disadvantages.

1. It is required to use a keyboard or a mouse as an input tool for users in the prior art; however, only handwriting or virtual keyboards are used for inputting in new-generation mobile devices.

2. The conventional input method is not intuitive, and is not easy and simple for using. Especially, in the mobile device, it requires to switch input modes or open another operation interface for handwriting or operating, such that the user must learn how to operate the operation interface before using the operation interface.

3. In the prior art, the searching for the both features of the picture and the text cannot be performed at the same time. The text search engine provides an operation interface for text input, and the picture search engine provides another operation interface for selection/inputting pictures. Therefore, the results for the text and picture query are irrelevant.

4. In the prior art, it is inconvenient to use the features of a picture for querying, and generally, only an entire picture can be selected as an input for querying. However, the user usually wants to query merely for a certain part of the picture. It is not precise for the user about the result for querying the entire picture.

### SUMMARY OF THE INVENTION

The present invention is directed to an input method, system and device for querying by using at least one region formed by at least one enclosed track, in which the text and/or an image to be queried is circled by an enclosed track. It can improve the convenience when a user queries the text-based and/or the image-based information by using an electronic device.

The present invention provides an input method for querying by using at least one region formed by at least one enclosed track, which is applicable to an electronic device. The input method includes: drawing at least one region on digital type information through a selection module, wherein each of regions is formed by the enclosed track; storing at least one of text information and image information of the digital type information in the at least one region into a registering memory; generating at least one of text-based information retrieval and image-based information retrieval according to the at least one of the text information and the image information, where the text-based information is generated by a text information conversion module according to the text information, and the image information is generated by an image information conversion module according to the image information; and submitting the at least one of the text-based information retrieval and the image-based information retrieval to at least one search engine for querying through a processing unit.

The present invention provides an input device for querying by using at least one region formed by at least one enclosed track, which includes: a display unit, a touch panel, a registering memory, a conversion module and a process unit. The display unit displays digital type information. The touch panel is disposed on the display unit, such that an object, for example finger or stylus, may slide on the surface of the touch panel so as to form an enclosed track on the digital type information. The registering memory is connected to the touch panel, and stores at least one of text information and image information in the at least one enclosed track. The conversion module is connected to the registering memory, and generates at least one of text-based information retrieval and image-based information retrieval according to the at least one of the text information and the image information. The process unit is connected to the display unit, the touch panel, the registering memory and the conversion module, and transmits at least one of the text-based information retrieval and the image-based information retrieval to at least one search engine.

The present invention provides an input system for querying by using at least one region formed by at least one enclosed track, which is applicable to an electronic device. The system includes: a selection module, for forming at least one enclosed track on the digital type information; a registering memory, for storing at least one of text information and image information in the at least one enclosed track drawn on the digital type information; a conversion module, including a text-based information conversion module and an image-based information conversion module, so as to generate at least one of text-based information retrieval and image-based information retrieval, where the text-based information conversion module generates the text-based information retrieval according to the text information, and the image-based information conversion module generates the image-based information retrieval according to the image information; and a process unit, for transmitting at least one of the text-based information retrieval and the image-based information retrieval to at least one search engine.

According to an embodiment of the present invention, in the method, the device and the system, the at least one region may be defined by the following: a moving track of a mouse, an area in a window drawn by a mouse, or a moving track of an object detected by the touch panel.

According to an embodiment of the present invention, in the method, the device and the system, the electronic device is any one of a desktop computer, a laptop computer, a tablet computer, a smart phone, a personal digital assistant (PDA), an interactive multimedia kiosk and a portable electronic device.

According to an embodiment of the present invention, in the method, the device and the system, it is further determined whether generated track signals form at least one enclosed track, and if an enclosed track is formed, at least one of text information and image information in the at least one enclosed track of the digital type information is captured according to the digital type information and the at least one region.

According to an embodiment of the present invention, in the method, the device and the system, when text information and image information in a corresponding enclosed track of the digital type information are captured at the same time, the text information and the image information are segmented so as to generate text-based information retrieval and image-based information retrieval.

According to an embodiment of the present invention, in the method, the device and the system, after the text-based information and the image-based information are segmented, the image-based information is used as image-based information retrieval, and part of texts in the text-based information is captured as text-based information retrieval according to the image-based information.

According to an embodiment of the present invention, in the method, the device and the system, part of texts in the text-based information is captured, a text extraction process is performed on the text-based information to extract one word, and then a correlation between the word and the image-based information is determined, and a word with the correlation value exceeding a threshold is used as text-based information retrieval.

### BRIEF DESCRIPTION OF THE DRAWINGS

The present invention will become more fully understood from the detailed description given herein below for illustration only, and thus are not limitative of the present invention, and wherein:

FIG. 1 is a block diagram of elements in an input system for querying by using at least one region formed by at least one enclosed track according to an embodiment of the present invention;

FIG. 2 is a flow chart of steps for querying by using at least one region formed by at least one enclosed track corresponding to FIG. 1;

FIG. 3 is a block diagram of elements in an input system for querying by using at least one region formed by at least one enclosed track according to another embodiment of the present invention;

FIG. 4 is a flow chart of querying texts according to one embodiment of the present invention;

FIG. 5 is a flow chart of querying images according to one embodiment of the present invention; and

FIG. 6 is a flow chart of querying texts and images together according to one embodiment of the present invention.

### DETAILED DESCRIPTION OF THE INVENTION

In order to make features and advantages of the present invention more comprehensible, the present invention is described in detail in the following with reference to the embodiments and accompanying drawings. The present invention is applicable to an electronic device, which is capable of providing a window operation interface, such as a desktop computer, a laptop computer, a tablet computer, a smart phone, a PDA, an interactive multimedia kiosk and a portable electronic device, and more particularly to an electronic device having or equipped with a touch screen. The touch screen refers to a screen capable of being touched by a finger or an object for operating. Generally, a pressure-sensitive touch panel is covered on a semi-penetration and semi-reflection LCD panel, and the touch pressure plate has high-sensitivity for pressure, and when an object is pressed on it, a current signal is generated to locate a pressure source for dynamic tracking.

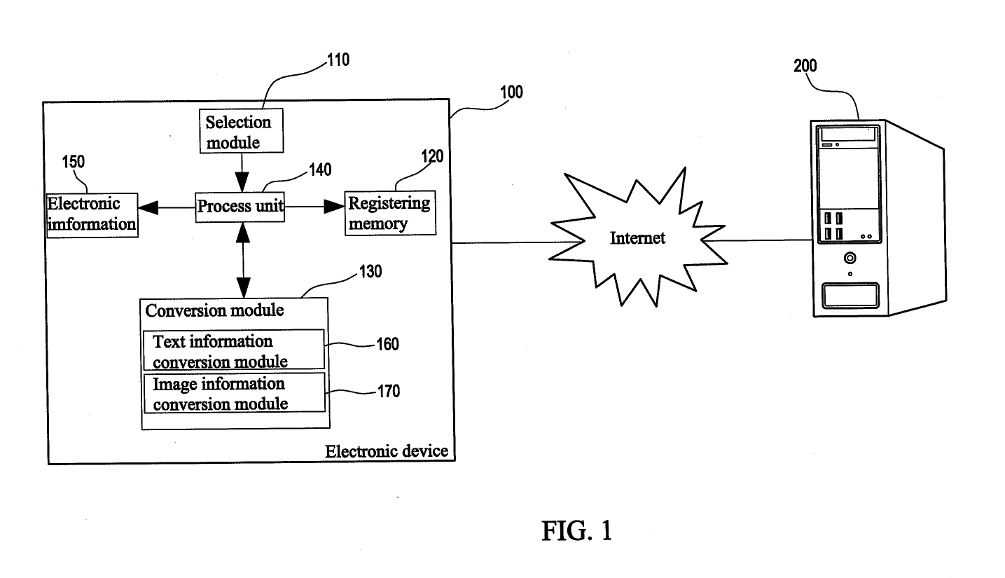

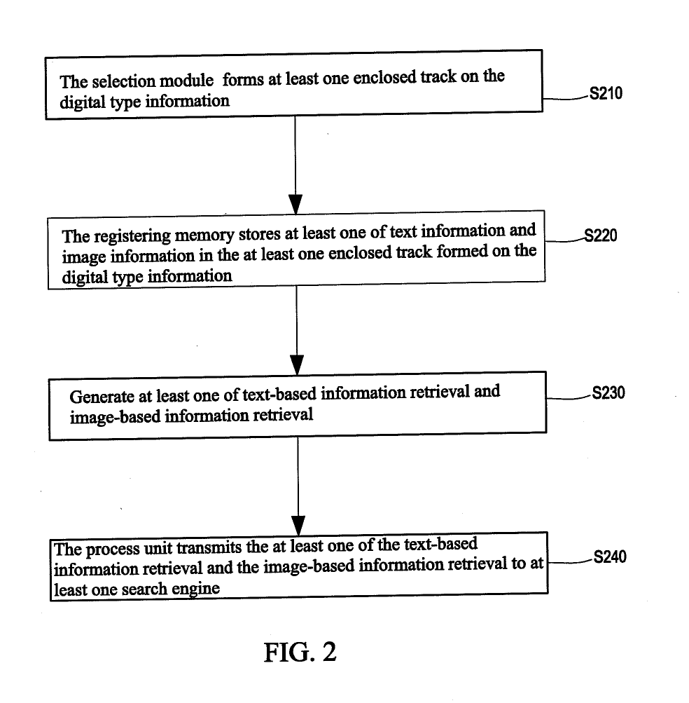

Referring to FIG. 1 and FIG. 2, FIG. 1 is a block diagram of elements in an input system for querying by using at least one region formed by at least one enclosed track according to an embodiment, and FIG. 2 is a flow chart of steps for querying by using at least one region formed by at least one enclosed track corresponding to FIG. 1. In FIG. 1, the input system for querying by using at least one region formed by at least one enclosed track is disposed in an electronic device 100 and mainly includes: a selection module 110, a registering memory 120, a conversion module 130 and a process unit 140. The process unit 140 is electrically connected to the selection module 110, the registering memory 120, and the conversion module 130. The electronic device 100 may further display digital type information 150 through a display (not shown in FIG. 1, the display may be a common screen or a touch screen) for users to browse. The digital type information 150 may be a webpage, an e-book content, or information/display operation interface/window provided by other application programs/commercial software.

The selection module 110 forms at least one enclosed track on the digital type information 150 (Step S210), where the selection module 110 detects a moving track of a mouse, or detects an area in a widow drawn by a mouse as the at least one region. In other embodiments, a touch track is detected as the at least one region by touching a touch screen. The at least one region may be a closed area defined by tracks, or a plurality of separate closed areas. When multiple enclosed tracks are circled by the user, no matter whether each enclosed track overlaps other enclosed tracks or not, the at least one region all enter the subsequent steps for data processing. That is to say, each enclosed track is compared with the digital type information 150 to obtain the information corresponding to the at least one region.

The registering memory 120 stores at least one of text information and image information in the at least one enclosed track formed on the digital type information 150 (Step S220). The registering memory may be a memory available in the market, such as SRAM, DRAM, DDR2 SDRAM, DDR3 SDRAM, or other memory devices.

In this embodiment, the step of obtaining at least one of the text information and the image information in the at least one region may be obtaining text information, obtaining image information, and obtaining text information and image information together. If both the text information and the image information are obtained at the same time, the step of segmenting the text-based information and the image information may be performed to generate text-based information retrieval and image-based information retrieval. The image information may be a part of an image in the digital type information 150, or the entire image in the digital type information 150. According to one embodiment, in this the step, a plurality of text-based information or image-based information can be obtained and proceeded at the same time as input for querying.

The conversion module 130 includes a text-based information conversion module 160 and an image-based information conversion module 170 to generate at least one of text-based information retrieval and image-based information retrieval (Step S230), where the text information conversion module 160 generates the text-based information retrieval according to the text-based information, and the image-based information conversion module 170 generates the image-based query information according to the image-based information.

In this step, when the text-based information is merely obtained in Step S220, only the text-based information retrieval is generated according to the text-based information. When the image-based information is merely obtained in Step S220, only the image-based information retrieval is generated according to the image-based information. When both the text-based information and the image-based information are obtained at the same time in Step S220, the text-based information retrieval is generated according to the text-based information and the image-based information retrieval is generated according to the image-based information. In other embodiments, a plurality of text-based information or a plurality of image-based information may be obtained at the same time to generate one or more pieces of text-based information retrieval, or to generate one or more image-based information retrieval.

The process unit 140 transmits the at least one of the text-based information retrieval and the image-based information retrieval to at least one search engine 200 (Step S240).

In this step, the search engine may be a text search engine and/or an image-based search engine. In other embodiments, the search engine may be a search engine capable of querying both text-based information and image-based information.

In this embodiment, the electronic device 100 may be connected to the search engine 200 through a communication network, so as to transmit the queried information to the at least one search engine 200 and receive a query result returned by the at least one search engine 200. In another embodiment, at least one search engine 200 may be disposed in the electronic device 100, and is electrically connected to the process unit 140. The process unit 140 directly transmits the query information to the at least one search engine 200 and receives the query result from the at least one search engine 200.

In this embodiment, the process unit 140 may further determine whether the track signal generated by the selection module 110 forms at least one enclosed track in Step S210, and captures at least one of text information or image-based information corresponding to the at least one enclosed track from the digital type information 150 if the at least one enclosed track is formed.

Furthermore, the process unit 140 may determine whether the information in the at least one region includes text and image information before Step S120, and if it is determined that the text-based information is included, then the text is extracted as the text information; while if it is determined that the image-based information is included, the image is extracted as the image information.

After segmenting the text-based information and the image-based information, the process unit 140 further uses the segmented image-based information as the image-based information retrieval, and captures part of texts from the segmented text information as the text-based information retrieval. In detail, the process unit 140 captures parts of texts from the text-based information, performs a text extraction process on the text information to extract one word, determines a correlation between the word and the image-based information, and uses a word with the correlation value exceeding a threshold as the text-based information retrieval for querying. The segmentation of the text information and the image information may be performed through a conventional method, which will be illustrated in detail below.

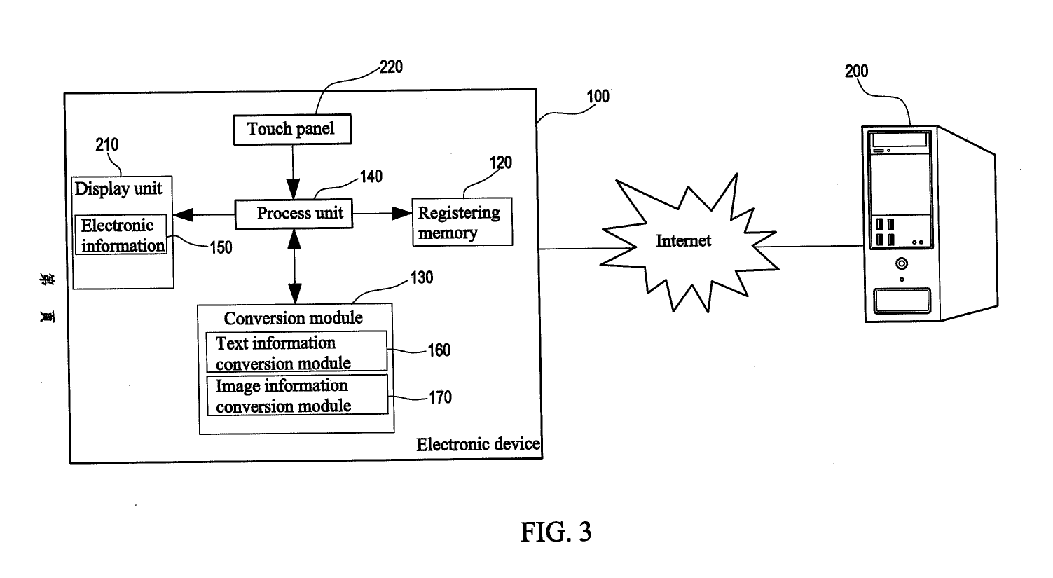

FIG. 3 is a block diagram of elements in an input system for querying by using at least one region formed by at least one enclosed track according to another embodiment of the present invention. In FIG. 3, the input system for querying by using at least one region formed by at least one enclosed track is disposed in an electronic device 100, and includes a display unit 210, a touch panel 220, a registering memory 120, a conversion module 130, and a process unit 140. The process unit 140 is electrically connected to the display unit 210, the touch panel 220, the registering memory 120 and the conversion module 130.

The display unit 120 displays digital type information 150. The touch panel 220 is disposed on the display unit 210, such that an object may slide on the surface of the touch panel so as to form an enclosed track on the digital type information 150. In this embodiment, the touch panel 220 may be the selection module in FIG. 1, and is formed by a touch pressure plate and a touch track detection module. The touch pressure plate is disposed on the display unit 210 to detect a moving track of an object on the touch pressure plate, and the touch track detection module outputs a track signal as the at least one region. The track detection technology is mainly using a touch track detection module to detect a moving track of the selection module on the touch panel and then output a track signal.

The registering memory 120 is connected to the touch panel 220 to store text-based information, image information, and at least one of the text information and the image information in the at least one region. The conversion module 130 is connected to the registering memory 120 to generate at least one of text-based information retrieval and image-based information retrieval according to the at least one of the text information and the image information. The process unit 140 is connected to the display unit 210, the touch panel 220, the registering memory 120 and the conversion module 130 to transmit the at least one of the text-based information retrieval and the image-based information retrieval to at least one search engine 200.

In an embodiment, the electronic device 100 may further include a communication unit (not shown in FIG. 3) connected to the search engine 200 through a wire or a wireless communication network. In another embodiment, the electronic device 100 may further include a search engine 200 electrically connected to the process unit 140.

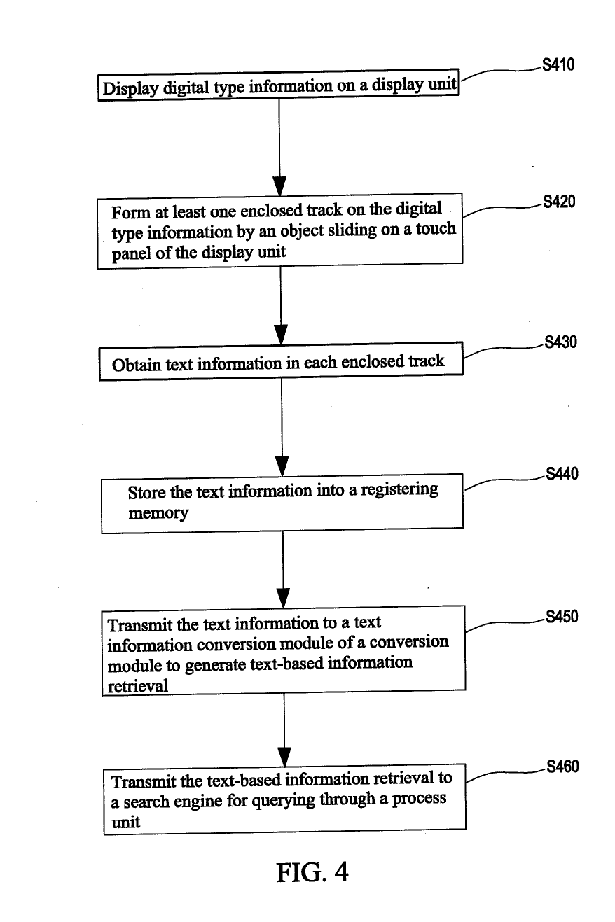

FIG. 4 is a flow chart of querying texts according to the present invention. Referring to the elements of the system in FIG. 3, the main steps are as follows.

Step S410: Display digital type information 150 on a display unit 210.

Step S420: Form at least one enclosed track on the digital type information 150 by an object sliding on a touch panel 220 of the display unit 210.

Step S430: Obtain text information in each enclosed track.

Step S440: Store the text information into a registering memory 120.

Step S450: Transmit the text information to a text information conversion module 160 of a conversion module 130 to generate text-based information retrieval.

Step S460: Transmit the text-based information retrieval to a search engine for querying through a process unit 140.

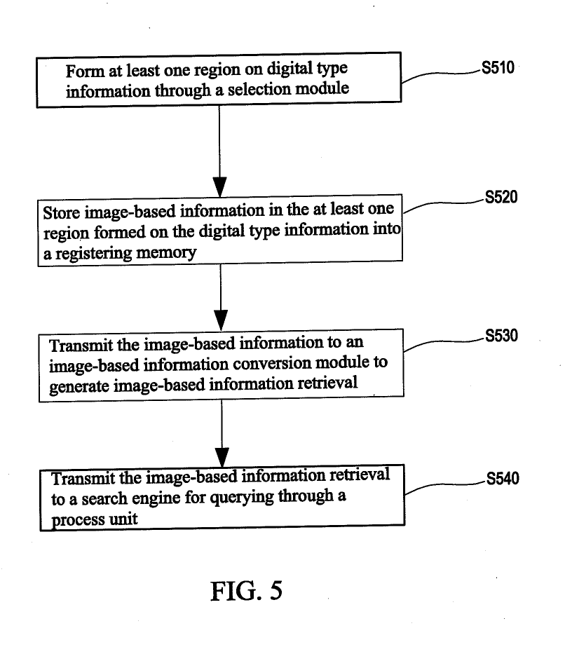

FIG. 5 is a flow chart of steps querying images according to one embodiment of the present invention. Referring to the elements of the system in FIG. 1, the main steps are as follows.

Step S510: Form at least one region on digital type information 150 through a selection module 110.

Step S520: Store image-based information in the at least one region formed on the digital type information 150 into a registering memory 120

In this step, the image-based information may be an entire image in the digital type information 150, or a part of an image in the digital type information 150, for example, a face in a photo.

Step S530: Transmit the image-based information to an image-based information conversion module 170 to generate image-based information retrieval.

Step S540: Transmit the image-based information retrieval to a search engine for querying through a process unit 140.

The embodiment shown in FIG. 4 and FIG. 5 describes the process steps when the user circles a text or an image on the digital type information. In one embodiment, it describes process steps when an enclosed track circled by the user includes both texts and images.

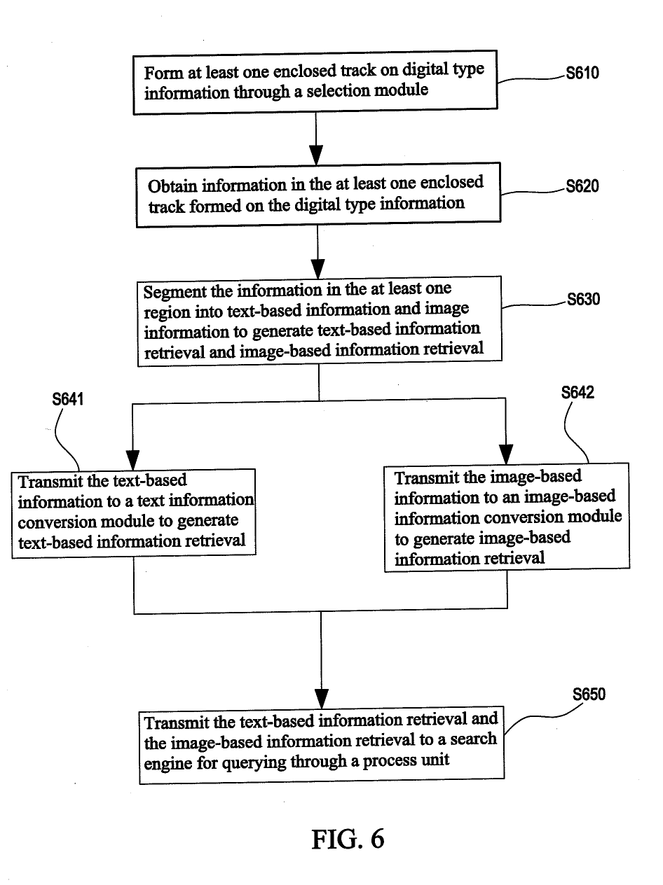

Referring to FIG. 6, a flow chart of querying texts and images together according to one embodiment of the present invention is shown. The main steps are as follows.

Step S610: Form at least one enclosed track on digital type information through a selection module.

Step S620: Obtain information in the at least one enclosed track formed on the digital type information.

Step S630: Segment the information in the at least one region into text-based information and image information to generate text-based information retrieval and image-based information retrieval.

After segmenting the text information and the image information, the process unit may further use the image information obtained through segmentation as the image-based information retrieval, and capture all or part of texts from the text-based information obtained through segmentation as the text-based information retrieval.

Generally speaking, when an image is circled, for example, an image may include multiple human faces, and when the user intends to circle one of the faces for input, the user may circle an area slightly wider than that of the face in the image. In one embodiment, all of contents in the circled area of the image are directly used as the image-based information retrieval. In another embodiment, the image processing method, the face recognition method or other conventional background filtering methods may be used to filter out the background of the circled area in the image, so as to obtain face features as the image-based information retrieval. Furthermore, when the image information is a human face, while the text information in the at least one region may include several characters of a name, a concrete noun having special meanings, for example, a name, may be extracted from the several characters in the at least one region as the text-based information retrieval through a natural language process (NLP, including automatic word segmentation/extraction, part of speech tagging, syntax analysis, natural language generation, text sorting, query information, information extraction, and text proofreading)

Furthermore, the NLP technology may perform a word extraction processing on the text information so as to extract at least one word, determine a correlation between the word and the image information, and use a word with the correlation value exceeding a threshold as the text-based information retrieval.

In Step S630, the information in the at least one region is segmented into the text-based information and the image-based information to generate the text-based information retrieval and the image-based information retrieval, where the information segmentation may be performed through a conventional image-based and text segmentation means. In an embodiment, when the information in the at least one region is a format of text wrap around images, the information in the at least one region may be divided into two parts by using an edge of the image, where one part is the image and the other part is the text. In another embodiment, the complicated images and texts may be segmented by other conventional image and text segmentation methods, for example, the text and the image are segmented through multiple steps such as (a) cluster analysis, (b) section query of the image and text, (c) text foreground extraction, and (d) image-based background compensation.

In still another embodiment, when the information in the at least one region is an image-and-text combination, the image part and the text part in the image-and-text combination may be separated by using a vague rule through the steps of (a) querying sections of the image and the text, (b) extracting parameters of three features such as the number of color, a projection histogram and a fractal dimension in the image, and (c) solving the three parameters to segment the image and the text.

Step S641: Transmit the text-based information to a text information conversion module to generate text-based information retrieval. The text information conversion module may generate the text-based information retrieval through the NLP technology, and moreover, the text-based information retrieval may be one or more key words.

Step S642: Transmit the image-based information to an image-based information conversion module to generate image-based information retrieval. The image-based information conversion module may generate the image-based information retrieval through the above image-based process technology or other recognition technologies.

Step S650: Transmit the text-based information retrieval and the image-based information retrieval to a search engine for querying through a process unit.

In this step, the text-based information retrieval may be transmitted to a text search engine for querying, and the image-based information retrieval may be transmitted to an image-based search engine for querying. When the text search engine and the image-based search engine respectively generate a query result, the text query result and the image-based query result may be transmitted back to the process unit, and then the process unit may integrate the text query result and the image-based query result to display.

In this embodiment, the electronic device may be any one of a computer, a notebook computer, a tablet computer, a smart phone, a PDA, an interactive multimedia kiosk and a portable electronic device.

In this embodiment, when the electronic device has or is connected to a device with a touch panel, the input system for querying by using at least one region formed by at least one enclosed track further includes a touch track detection module to detect a moving track of an object on the touch panel and output a track signal. The process unit computes and determines whether the moving track of the object on the touch panel forms an enclosed track according to the track signal, and if an enclosed track is formed, captures at least one of text information and image information in the at least one region of the digital type information according to the digital type information and the at least one region.

To sum up, the present invention has the following advantages.

1. The present invention may circle a word to be queried, and input the word directly and rapidly.

2. The present invention may conveniently input the text and the picture information, and rapidly and conveniently querying the related information during the browsing of the information.

3. The present invention may conveniently use the picture and partial information of the picture for querying, thus avoiding low correlation between the analysis result and the image-based main body due to complicated background of the image-based main body.

4. The present invention is unnecessary to depend on the keyboard as the main input device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An input method for querying by using at least one region formed by at least one enclosed track, applicable to an electronic device, and comprising:
forming at least one region on digital type information through a selection module, wherein each of regions is formed by the enclosed track;
storing at least one of text information and image information in the at least one region on the digital type information into a registering memory;
generating at least one of text-based information retrieval and image-based information retrieval according to at least one of the text information and the image information, wherein the text-based information is generated by a text information conversion module according to the text information, and the image information is generated by an image information conversion module according to the image information;
and transmitting the least one of the text-based information retrieval and the image-based information retrieval to at least one search engine for querying through a process unit.

2. The input method for querying by using at least one region formed by at least one enclosed track according to claim 1, wherein the electronic device further comprises a touch panel as the selection module, and the touch panel comprises a touch pressure plate on a display unit to detect a moving track of an object, and the step of forming the at least one region on the digital type information further comprises a track detection technology implemented in the following step, and the touch track detection module outputs a track signal as the at least one region.
outputing a track signal as the track by a touch track detection module according to the moving track of the object.

3. The input method for querying by using at least one region formed by at least one enclosed track according to claim 1, wherein in the step of obtaining at least one of the text-based information and the image-based information in the at least one region, it is performed by at least one of obtaining the text-based information, obtaining the image-based information, and obtaining the text-based information and the image-based information at the same time.

4. The input method for querying by using at least one region formed by at least one enclosed track according to claim 3, wherein when the step of obtaining at least one of the text-based information and the image-based information in the at least one region it is performed by obtaining the text-based information and the image-based information at the same time, the method further comprises:
extracting the text-based information and the image-based information.

5. An input system for querying by using at least one region formed by at least one enclosed track, applicable to an electronic device, and comprising:
a selection module, for forming at least one region on digital type information;
a registering memory, for storing at least one of text information and image information in the at least one region formed on the digital type information;
a conversion module, comprising a text-based information process and an image-based information process, so as to generated by a text-based information retrieval and image-based querying information, wherein the text information conversion module generates the text-based information retrieval according to the text information, and the image information conversion module generates the image query information according to the image-based information; and
a process unit, for submitting a query the least one of the text-based information retrieval and the image-based information retrieval to at least one search engine.

6. The input system for querying by using at least one region formed by at least one enclosed track according to claim 5, wherein the selection module detects a moving track of a mouse as the at least one region.

7. The input system for querying by using at least one region formed by at least one enclosed track according to claim 5, wherein the selection module detects a window range generated after a mouse clicks as the at least one region.

8. The input system for querying by using at least one region formed by at least one enclosed track according to claim 5, wherein the selection module further comprises a touch pressure plate and a touch track detection module, the touch pressure plate is disposed on a display unit to detect a moving track of an object on the touch pressure plate, and the touch track detection module outputs a track signal as the at least one region.

9. The input system for querying by using at least one region formed by at least one enclosed track according to claim 5, wherein the electronic device is one of a computer, a notebook computer, a tablet computer, a smart phone, a personal digital assistant (PDA), an interactive multimedia kiosk and a portable electronic device.

10. The input system for querying by using at least one region formed by at least one enclosed track according to claim 5, wherein the process unit further judges whether the track generated by the selection module forms the at one enclosed track, and if a track of the at least one enclosed track is formed, captures at least one of the text information and the image information in the at least one region in the digital type information according to the digital type information and the at least one region.

11. The input system for querying by using at least one region formed by at least one enclosed track according to claim 5, wherein the image information is a part of an image in the digital type information.

12. The input system for querying by using at least one region formed by at least one enclosed track according to claim 5, wherein the process unit further segments the text information and the image information to generate the text-based information retrieval and the image query information when capturing the text information and the image information in the at least one region in the digital type information at the same time; and after segmenting the text information and the image information, uses the segmented image-based information as the image query information, and extracts a query of text from the source text-based information as the text-based information retrieval according to the image information.

13. The input system for querying by using at least one region formed by at least one enclosed track according to claim 5, wherein the process unit captures a part of text from the text information is performed by a text extraction process on the text information to extract one word, computing correlation between the word and the image information, and uses a word with the correlation value exceeding a threshold as the text query information.

14. An input device for querying by using at least one region formed by at least one enclosed track, comprising:
a display unit, for displaying digital type information;
a touch panel, disposed on the display unit, for an object to slide thereon and forming at least one enclosed track on the digital type information;
a registering memory, connected to the touch panel, for storing at least one of text information and image information in the track of the at least one enclosed track;
a conversion module, connected to the registering memory, for generating at least one of text-based information retrieval and image-based information retrieval according to at least one of the text information and the image information; and
a process unit, connected to the display unit, the touch panel, the registering memory and the conversion module, for submitting at least one of the text-based information retrieval or the image-based querying information to at least one search engine.
